(19) United States
(12) Patent Application Publication
(10) Pub. No.: US 2014/0255074 A1
(43) Pub. Date: Sep. 11, 2014

(54) TENSION ADJUSTMENT DEVICE FOR ADJUSTING TENSION OF A CARBON TAPE WITHIN A PRINTER

(71) Applicant: TSC AUTO ID TECHNOLOGY CO., LTD., Taipei City (TW)

(72) Inventor: I-CHE YU, YILAN COUNTY (TW)

(73) Assignee: TSC AUTO ID TECHNOLOGY CO., LTD., TAIPEI CITY (TW)

(21) Appl. No.: 13/785,351

(22) Filed: Mar. 5, 2013

(51) Int. Cl. B41J 33/16

(52) U.S. Cl. CPC B41J 33/16
USPC 400/234

(57) ABSTRACT

A tension adjustment device includes a swing arm having a central portion defining a pivot point; a tape guide rod sleeved rotatably on a left portion of the swing arm; a stop block disposed on the swing arm; a biasing member having one end fixed to a fixing element and a second end biasing the swing arm; a carrier disk disposed adjacent to and biased by the stop block; and a reel of carbon tape mounted on the carrier disk, and having a carbon tape with a predetermined tape section trained around the tape guide rod in such a manner to be dispensed outward along a dispensing path. During the dispensing operation, a total tension force is generated on the tape guide rod due to two tension forces caused by trained on of the predetermined tape section, wherein, the stop block disengages from the carrier disk.

### BACKGROUND OF THE INVENTION

1. Field of the Invention

The present invention relates to a tension adjustment device for a printer, more particularly to a tension adjustment device including a swing arm and a biasing member, which provides a biasing action so as to adjust tension of a carbon tape within the printer.

2. Description of the Prior Art

Generally, a majority of domestic utensils and commercial products we see daily, are printed with barcodes, which disclose information about the respective utensil or product. A conventional barcode label printer includes a reel of paper and a printing head, wherein relative position of the printing head with respect to the paper reel is fixed so that the user can not adjust the relative position between the printing head and the paper reel. In the event that the carbon tape or the paper tape is not able to complement with the printing head for practical application owing to the thickness, displacement of the barcode printed out from the printer can be resulted such that the printed barcode is displaced from its initial position. Under this condition, the printing head suffers the non-uniform thermal conduction at two lateral contact sides with respect to the initial positions and resulting in non-uniform tension of the carbon tape, which leads to wrinkles in the printed barcode, thereby degrading the quality of the product. In addition, the printing head in a conventional barcode printer is not provided with an adjustment screw such that when the pressure at two sides of the printing head is not complement with the relative position, the tension of the carbon tape can not be adjusted effectively, thereby affecting and degrading the quality of a product printed with a barcode.

In order to solve the abovementioned drawbacks, the conventional art discloses a printer, in which, an adjustment rod is inserted through a rear portion of the printing head while and a tape frame is mounted to two pivot holes in a front portion of the printing head. On end of the adjustment rod is formed with a screw chamber for receiving an adjustment screw such that movement of the adjustment screw within the screw chamber results in forward and rearward movement of the adjustment rod relative to the printing head, thereby altering the contact position of the printing head with respect to the paper reel, where the printing head provides uniform thermal conduction and the carbon tape does not surfer loose tension and is free of wrinkles.

However, the abovementioned patent still has some problems, such as, the user needs to adjust the tension of the carbon tape depending on the practical requirement. Hence, a relatively large amount of time is required if the printer is to provide the best printing quality. In addition, the tension structural design of the carbon tape applies equal torque application such that in case of variation at the width of carbon tape, loose tension of the latter may occur when the width increases or over tension of the carbon tape may occur when the width decreases, hence the user may encounter inconvenient when adjusting the tension of the carbon tape.

### SUMMARY OF THE INVENTION

Since the conventional barcode printer commonly has wrinkles loose tension in the carbon tape and since it requires a relatively large amount of time is required for adjusting the tension of the carbon tape to provide the best printing quality due to variation in the widths, the main object of the present invention is to provide a tension adjustment device for a printer. The tension adjustment device includes a swing arm and a biasing member, which provides a biasing action for cooperating with and interactively controlling the tension of the carbon tape during the dispensing operation of the carbon tape so as to adjust the tension of carbon tapes with different widths.

The tension adjustment device of the present invention is employed in a printer, and includes an elongated swing arm having a central portion defining a pivot point; a tape guide rod sleeved rotatably on a left portion of the elongated swing arm; a stop block disposed on a right portion of the elongated swing arm; a biasing member having a first end fixed to a fixing element and a second end biasing the right portion of the elongated swing arm; a carrier disk disposed adjacent to and being biased by the stop block due to biasing action of the biasing member; and a reel of carbon tape mounted on the carrier disk, and having a carbon tape with a predetermined tape section trained around the tape guide rod in such a manner to be dispensed outward along a dispensing path. During a dispensing operation, a total tension force is generated on the tape guide rod due to two tension forces caused by trained on of the predetermined tape section of the carbon tape, wherein, the stop block disengages from the carrier disk to permit the dispensing operation, when a torque applied by the total tension force on the pivot point of the elongated swing arm is greater than a torque applied by the biasing member on the pivot point of the elongated swing arm and vice versa.

Preferably, the biasing member is disposed on one side of the elongated swing arm opposite to the stop block for biasing the stop block to abut against the carrier disk, thereby preventing the carrier disk from rotating. The biasing member is a coil spring. A position of the fixing element is adjustable in order to permit adjustment of an initial biasing force of the coil spring. The printer is selected from a group consisting of a barcode label printing device and tag label printing device.

When compared with the conventional barcode label printer, the tension adjustment device of the present invention utilizes a biasing member for biasing the swing arm at one end portion such that the biasing action cooperates with a total tension force generated on the tape guide rod due to training on of the predetermined tape section of the carbon tape during the dispensing operation, to automatically alter the tension force of the carbon tape regardless of different width. In other words, the user does not need a relatively large amount of time to manually adjust the tension of the carbon tape regardless of its different widths, thereby eliminating the wrinkles and loose tension caused to the carbon tape employed in the adjustment device of the present invention.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a schematic view of a tension adjustment device for a printer according to the present invention in a first state; and

FIG. 2 shows a schematic view of the tension adjustment device for a printer according to the present invention in a second state.

### DETAILED DESCRIPTION OF THE PREFERRED EMBODIMENT

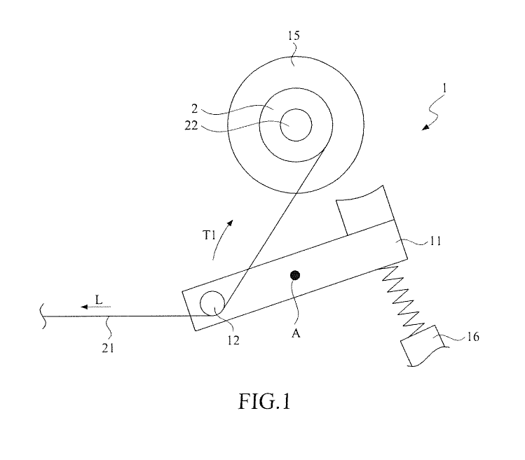

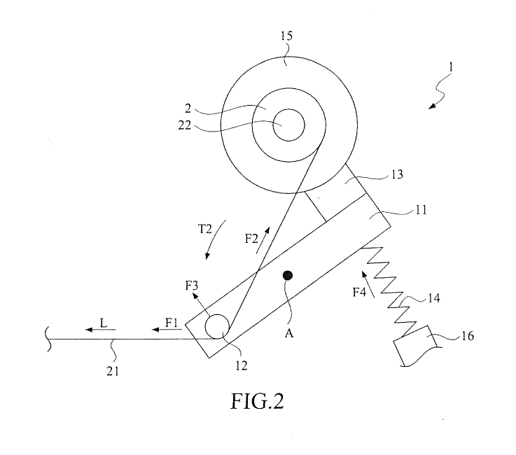

Referring to FIGS. 1 and 2, wherein FIG. 1 shows a schematic view of a tension adjustment device for a printer according to the present invention in a first state while FIG. 2 shows a schematic view of the tension adjustment device for a printer according to the present invention in a second state. As illustrated, the tension adjustment device 1 of the present invention is implemented in a printer (not visible), which is preferably selected from a group consisting of a barcode label printer and tag label printer. In this embodiment, the tension adjustment device 1 of the present invention is implemented in a barcode label printer, however, the scope of the present invention should not be limited only thereto.

The tension adjustment 1 of the present invention includes an elongated swing arm 11, a tape guide rod 12, a stop block 13, a biasing member 14, a carrier disk 15 and a reel of carbon tape 2. The elongated swing arm 11 has a central portion defining a pivot point (A) such that the two end portions thereof are rotatable about the pivot point (A). In this embodiment, the elongated swing arm 11 is mounted securely to the barcode label printer a pivot pin which serves as the pivot point (A) of the swing arm 11. Note that mounting of the swing arm 11 to the printer should not be limited only to the pivot pin, any other method can be implemented so long as two portions of the swing arm are rotatable about the pivot point (A).

The tape guide rod 12 is sleeved rotatably on the elongated swing arm 11. Preferably, the tape guide rod 12 is sleeved rotatably on a left portion of the swing arm 11, as best shown in FIG. 1. Mounting of the tape guide rod 12 on the swing arm 11 should not be limited only to the sleeving means, any other method can be implemented so long as the tape guide rod 12 can smoothly guide the carbon tape 2 under proper tension thereon. The stop block 13 disposed securely on a right portion of the elongated swing arm 11, as best shown in FIG. 2. Preferably, the stop block 13 is disposed securely on one side of the swing arm 11.

The biasing member 14 has a first end fixed to a fixing element 16 and a second end biasing the right portion of the elongated swing arm 11. To be more specific, the first end of the biasing member 14 is fixed on the other side of the elongated swing arm 11 opposite to the stop block 13. In this embodiment, a coil spring serves as the biasing member 14. The position of the fixing element 16 is adjustable in order to permit adjustment of an initial biasing force of the coil spring 14. Preferably, some adjustable member such as a cam wheel or a threaded bolt, which initial position is adjustable should serve as the fixing element is this embodiment, however the scope of the present invention should not be limited only thereto.

The carrier disk 15 is disposed adjacent to and is biased by the stop block 13 due to biasing action of the biasing member 14. Preferably, the carrier disk 15 is mounted securely within the barcode label printer via a pivot shaft such that is rotatable on its own axis. The reel of carbon tape 2 is mounted on the carrier disk 15, and has a carbon tape 22 with a predetermined tape section 21 trained around the tape guide rod 12 in such a manner to be dispensed outward along a dispensing path L.

When the barcode label printer provided with the tension adjustment device 1 of the present invent is not in use, the carrier disk 15 is prevented by from rotation on its own axis due to abutment of the stop block 13 against the carrier disk 15.

However, when the barcode label printer provided with the tension adjustment device 1 of the present invent is in use, i.e., during the tape dispensing operation, a pull force is applied on the carbon tape 22 such that a total tension force F 3 is generated on the tape guide rod 12 due to two tension forces F1, F2 (shown by two arrows) caused by trained on of the predetermined tape section 21 of the carbon tape 22 to permit rotation of the swing arm 11 about the pivot point (A) in the T1 direction, wherein, the stop block 13 disengages from the carrier disk 15 to permit the dispensing operation, when a torque applied by the total tension force F3 on the pivot point (A) of the elongated swing arm 11 is greater than a torque F4 applied by the biasing member 14 on the pivot point (A) of the elongated swing arm 11. In the event (when the printer is not in use), a torque F4 applied by the biasing member 14 on the pivot point (A) of the elongated swing arm 11 is greater than a torque applied by the total tension force F3 on the pivot point (A) of the elongated swing arm 11 such that the swing arm 11 rotates about the pivot axis (A) in the T2 direction, thereby biasing the stop block 13 to engage the carrier disk 15 and hence the carrier disk 15 is prevented from rotation about its own axis.

As described above, when a printer provided with the tension adjustment device 1 of the present invention is in use, the user does not need to apply a relatively large amount of force for adjusting the tension of the reel of carbon tape 21 due to interactively control action between the reel of carbon tape 21 and the biasing member 14 such that the tension of the reel of carbon tape 21 is automatically adjusted and altered regardless of different width in the tape. In other words, the user does not need a relatively large amount of time to manually adjust the tension of the carbon tape regardless of its different widths, thereby eliminating the wrinkles and loose tension caused to the carbon tape employed in the adjustment device of the present invention. In addition, since no electrical circuits or any motor is employed to achieve the automatical adjustment of the carbon tape, no extra manufacturing expense is resulted.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A tension adjustment device for a printer, comprising:
an elongated swing arm having a central portion defining a pivot point;
a tape guide rod sleeved rotatably on a left portion of said elongated swing arm;
a stop block disposed on a right portion of said elongated swing arm;
a biasing member having a first end fixed to a fixing element and a second end biasing the right portion of said elongated swing arm;
a carrier disk disposed adjacent to and being biased by said stop block due to biasing action of said biasing member; and
a reel of carbon tape mounted on said carrier disk, and having a carbon tape with a predetermined tape section trained around said tape guide rod in such a manner to be dispensed outward along a dispensing path ;
wherein, during a dispensing operation, a total tension force is generated on said tape guide rod due to two tension forces caused by trained on of said predetermined tape section of said carbon tape, wherein, said stop block disengages from said carrier disk to permit said dispensing operation, when a torque applied by said total tension force on said pivot point of said elongated swing arm is greater than a torque applied by said biasing member on said pivot point of said elongated swing arm and vice versa.

2. The tension adjustment device according to claim 1, wherein said biasing member is disposed on one side of said elongated swing arm opposite to said stop block for biasing said stop block to abut against said carrier disk when not in use.

3. The tension adjustment device according to claim 1, wherein said biasing member is a coil spring.

4. The tension adjustment device according to claim 3, wherein a position of said fixing element is adjustable in order to permit adjustment of an initial biasing force of said coil spring.

5. The tension adjustment device according to claim 1, wherein the printer is selected from a group consisting of a barcode label printer and tag label printer.
